(19) United States
(12) Patent Application Publication
(10) Pub. No.: US 2013/0315662 A1
(43) Pub. Date: Nov. 28, 2013

(54) JIG AND A CONNECTOR

(71) Applicant: Sumitomo Wiring Systems, Ltd., Yokkaichi-City (JP)

(72) Inventor: Shinjiro Kida, Yokkaichi-City (JP)

(73) Assignee: Sumitomo Wiring Systems, Ltd., Yokkaichi-City (JP)

(21) Appl. No.: 13/893,566

(22) Filed: May 14, 2013

(30) Foreign Application Priority Data
May 25, 2012 (JP) 2012-119857

(51) Int. Cl. F16B 17/00

(52) U.S. Cl. CPC F16B 17/002
USPC 403/280

(57) ABSTRACT

A jig (40) is used to resiliently deform a locking lance (15) in an unlocking direction by being moved in a direction intersecting with a resilient deforming direction of the locking lance (15) in unlocking the locking lance (15), and includes an unlocking surface (46) which is inclined with respect to both the resilient deforming direction of the locking lance (15) and a moving direction of the jig (40) and pushes and resiliently deforms the locking lance (15) in the unlocking direction in a moving process during an unlocking operation, and a terminal pushing portion (50) which pushes and displaces a terminal fitting (30) in a direction away from the locking lance (15) with respect to the resilient deforming direction of the locking lance (15) in the moving process during the unlocking operation.

### BACKGROUND

1. Field of the Invention

The invention relates to a jig and a connector.

2. Description of the Related Art

Japanese Unexamined Patent Publication No. 2008-270026 discloses a connector in which a terminal fitting inserted into a terminal accommodating chamber of a housing is retained by the locking action of a locking lance and the locking lance is resiliently deformed by a jig to be unlocked in withdrawing the terminal fitting from the terminal accommodating chamber. The jig is moved relative to the locking lance in a direction intersecting with a resilient deforming direction of the locking lance and pushes the locking lance by an unlocking surface inclined with respect to the resilient deforming direction of the locking lance, whereby the locking lance is resiliently deformed.

In the above connector, a movement stroke of the jig necessary for unlocking is substantially proportional to the amount of resilient deformation of the locking lance necessary for unlocking. Thus, if the amount of resilient deformation necessary to unlock the locking lance is large, the movement stroke of the jig becomes longer by that much, which may lead to a reduction in operability. Further, if the jig is displaced in a direction intersecting with a moving direction in the process of being moved to resiliently deform the locking lance in an unlocking direction, the unlocking surface pushes the locking lance at a timing other than a specified one and the resilient deformation of the locking lance may be insufficient. In this case, operability is reduced since the jig needs to be moved again.

The invention was completed in view of the above situation and an object thereof is to improve operability in resiliently deforming a locking lance in an unlocking direction by a jig.

### SUMMARY OF THE INVENTION

The invention relates to a jig to be used for a connector including a locking lance resiliently deformable in a direction intersecting an insertion direction of a terminal fitting into a terminal accommodating chamber and configured to retain the terminal fitting inserted into the terminal accommodating chamber by the locking action of the locking lance. The jig is configured to resiliently deform the locking lance in an unlocking direction by being moved in a direction intersecting a resilient deforming direction of the locking lance. The jig has an unlocking surface that is inclined with respect to both the resilient deforming direction of the locking lance and a moving direction of the jig. The unlocking surface pushes and resiliently deforms the locking lance in the unlocking direction in a moving process during an unlocking operation. The jig also has a terminal pushing portion that pushes and displaces the terminal fitting in a direction away from the locking lance with respect to the resilient deforming direction of the locking lance in the moving process during the unlocking operation.

According to this configuration, the terminal fitting is pushed back by the push-back portion when the unlocking operation is completed. Thus, the terminal fitting and the locking lance interfere with each other and the locking lance is kept in an unlocked state even without being resiliently deformed by the jig. Thereafter, the terminal fitting can be withdrawn even without performing the unlocking operation by the jig. Therefore, operability is better as compared with the case where the terminal fitting is withdrawn with the unlocking operation by the jig continued.

The terminal pushing portion may be configured to push a corner of a tube of the terminal fitting and to be locked by the locking lance in a diagonal direction. According to this configuration, a contact area when the terminal pushing portion pushes the terminal fitting is smaller as compared with the case where the terminal pushing portion pushes a planar portion of the tube, and sliding resistance between the terminal pushing portion and the tube is reduced by that much. Therefore, operability is excellent.

The jig may further comprise a stopper that contacts a housing of the connector when the jig is moved to a position where the unlocking operation is completed. Accordingly, the unlocking operation by the jig can be completed reliably.

The jig may further comprise a guidable portion that is to be tightly inserted into a guide hole of the connector without shaking in the vertical and/or lateral directions.

The disengaging portion may include a support substantially in the form of a plate that is long in forward and backward directions. The disengaging portion preferably extends forward from the guidable portion and is displaced from the unlocking portion in the lateral direction.

A lateral dimension of the support preferably is less than a lateral dimension of the guidable portion and a vertical dimension of the support preferably is equal to vertical dimensions of the guidable portion and the unlocking portion.

The invention also relates to a connector with a housing that has at least one terminal accommodating chamber and at least one terminal fitting is to be inserted into the terminal accommodating chamber. At least one locking lance extends along an inner wall of the terminal accommodating chamber and is resiliently deformable in a direction intersecting an insertion direction of the terminal fitting. The locking lance is configured to engage and retain the terminal fitting. The terminal fitting is displaced in a direction away from the locking lance with respect to a resilient deforming direction of the locking lance by a terminal pushing portion of a jig and the locking lance is resiliently deformed in an unlocking direction by an unlocking surface of the jig in the process of moving the jig in a direction intersecting the resilient deforming direction of the locking lance. At least one guide is formed in the housing to substantially extend along a moving direction of the jig during an unlocking operation and restricts improper displacements of the jig in directions intersecting the moving direction of the jig.

The jig may comprise a guidable portion to be tightly inserted into a guide hole of the connector without shaking in the vertical and/or lateral directions.

The disengaging portion may include a support that extends forward from the guidable portion displaced from the unlocking portion in the lateral direction. The support is a plate that is long in forward and backward directions.

A lateral dimension of the supporting portion may be less than a lateral dimension of the guidable portion and a vertical dimension of the support may be equal to vertical dimensions of the guidable portion and/or the unlocking portion.

These and other features and advantages of the invention will become more apparent upon reading the following detailed description and accompanying drawings.

### BRIEF DESCRIPTION OF THE DRAWINGS

FIG. 1 is a front view showing a state where a jig is inserted in a housing in one embodiment.

FIG. 2 is a front view showing a state where a front retainer is detached from a main body of the housing.

FIG. 3 is a section along A-A of FIG. 1 showing the process of an unlocking operation by the jig.

FIG. 4 is a section along B-B of FIG. 1 showing the process of the unlocking operation by the jig.

FIG. 5 is a section along A-A of FIG. 1 showing a state where the unlocking operation by the jig is completed.

FIG. 6 is a section along B-B of FIG. 1 showing the state where the unlocking operation by the jig is completed.

FIG. 7 is a section along C-C of FIG. 3.

FIG. 8 is a section along D-D of FIG. 3.

FIG. 9 is a perspective view showing a state where the jig is vertically inverted.

### DETAILED DESCRIPTION OF THE PREFERRED EMBODIMENTS

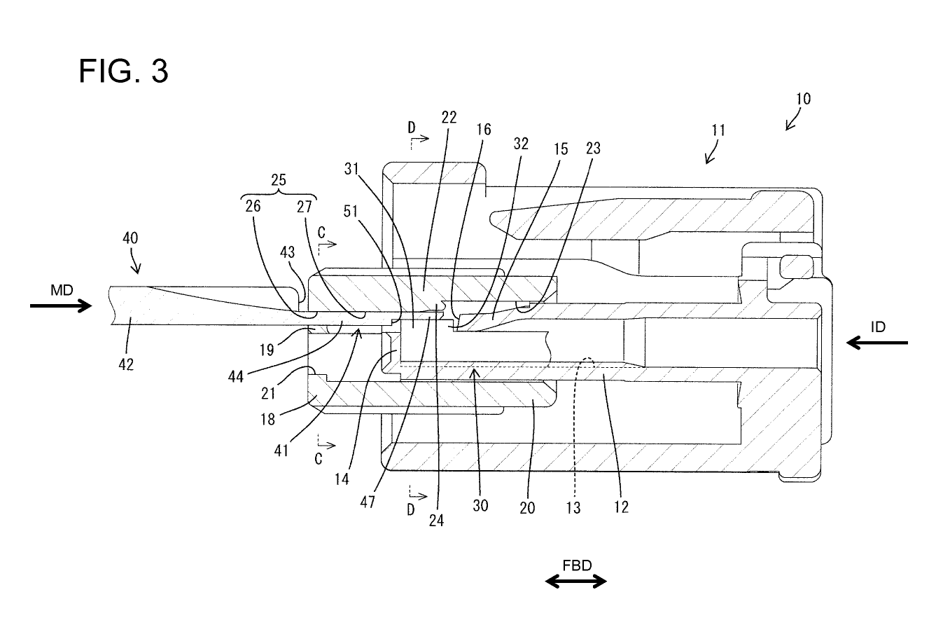

A connector in accordance with the invention is identified by the numeral 10 in FIGS. 3 to 6. The connector 10 includes a housing 11 and one or more terminal fittings 30. The housing 11 particularly is composed of or comprises two members, i.e. a main body 12 made e.g. of synthetic resin and a front retainer 18 to be mounted onto the main body 12 particularly from front (left side in FIGS. 3 to 6). Terminal accommodating chambers 13 penetrate the main body 12 in forward and backward directions FBD. A front stop 14 is formed at or near the front end of the terminal accommodating chamber 13. The terminal fitting 30 is to be inserted into the terminal accommodating chamber 13 from behind and stopped at a proper insertion position so as not to move any further in the inserting direction ID by contacting the front stop 14. An insertion direction ID of the terminal fitting 30 is substantially parallel to a moving direction MD of a jig 40 to be described later during an unlocking operation.

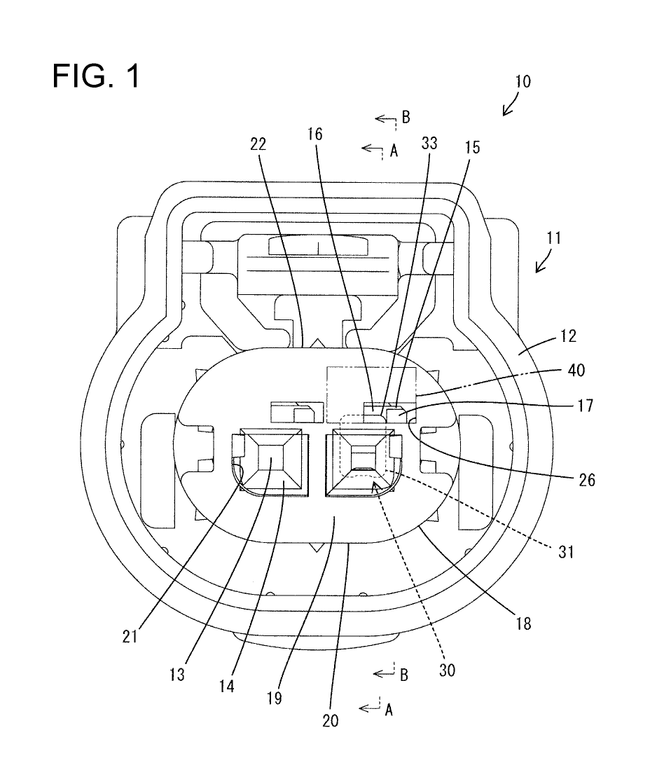

The terminal fitting 30 is long and narrow in forward and backward directions FBD. As shown in FIGS. 1, 7 and 8, a substantially rectangular tube 31 having a vertically long rectangular frontal shape is formed at a front part of the terminal fitting 30. A front end of the upper surface of the rectangular tube 31 is set to be higher than a rear end with a step formed therebetween, and a locking portion 32 is formed on the upper or outer surface of the rectangular tube 31 due to this height difference. Further, a small clearance (not shown) for enabling the terminal fitting 30 to be smoothly inserted into the terminal accommodating chamber 13 is secured between the inner wall surface of the terminal accommodating chamber 13 and the outer surface of the rectangular tube 31. Due to this clearance, the rectangular tube 31 is slightly displaceable in vertical and/or lateral directions in the terminal accommodating chamber 13. Both vertical and/or lateral directions are directions intersecting the insertion direction ID of the terminal fitting 30.

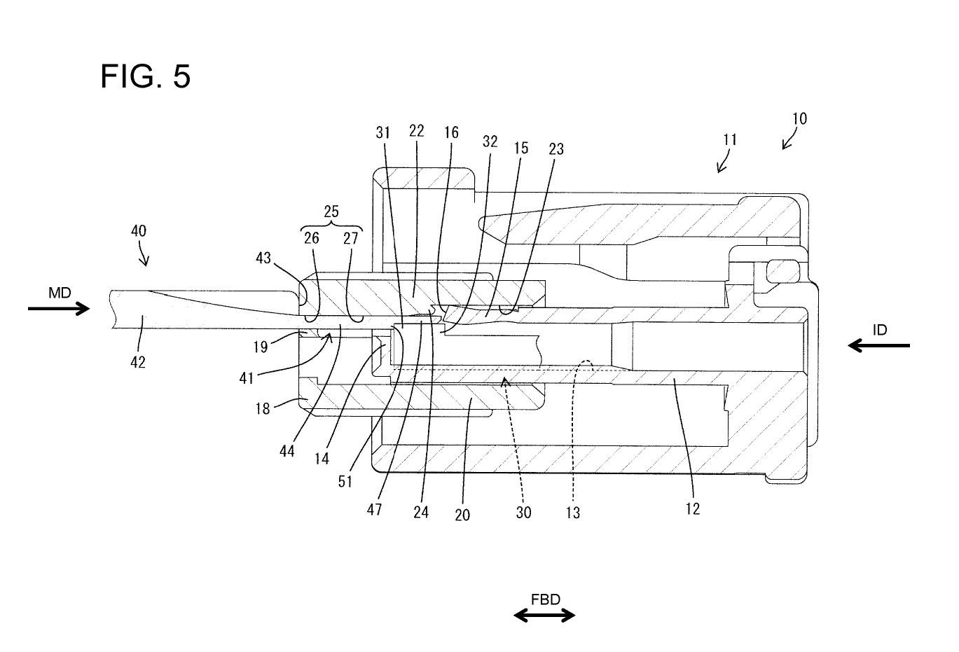

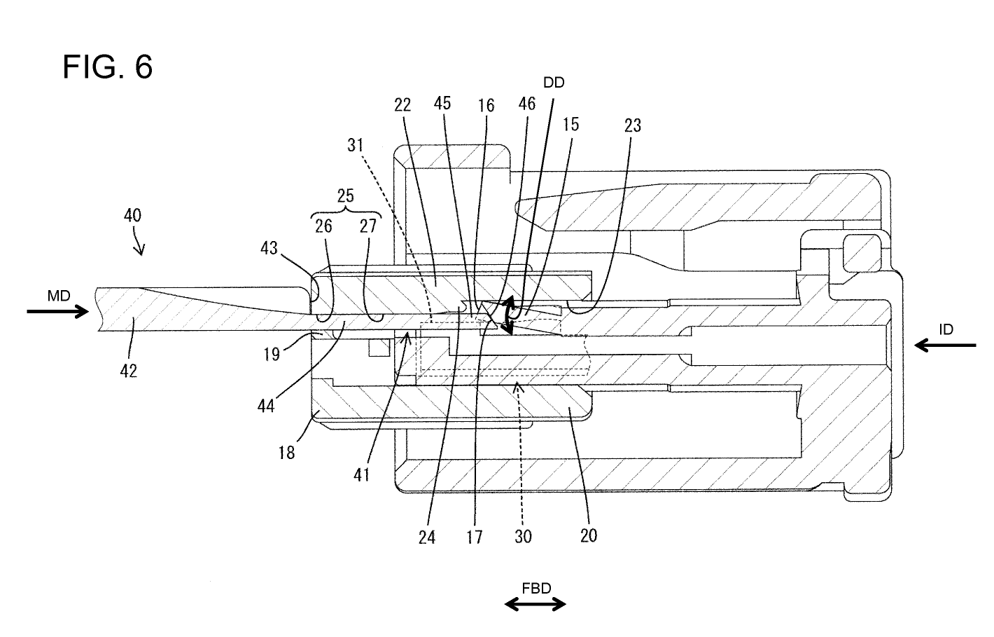

As shown in FIGS. 3 to 6, locking lances 15 are cantilevered substantially in the inserting direction ID and along the upper inner wall surfaces of the terminal accommodating chambers 13 are formed in the main body 12. As shown in FIGS. 5 and 6, the locking lance 15 is resiliently deformable up in a deforming direction DD so as to move away from the upper surface of the rectangular tube 31. In the process of inserting the terminal fitting 30 into the terminal accommodating chamber 13, the rectangular tube 31 resiliently deforms and retracts the locking lance 15 up in the deforming direction DD. When the terminal fitting 30 reaches the proper insertion position, the locking lance 15 resiliently restores, and a locking surface 16 on the front end of the locking lance 15 engages the locking portion 32 from a disengaging side or from behind, and the terminal fitting 30 is held and retained by this locking action. The locking lance 15 can be deformed resiliently up in the deforming direction DD (i.e. unlocking direction) by using the jig 40 so that the locked state of the terminal fitting 30 by the locking lance 15 can be released and the terminal fitting 30 can be withdrawn in a direction opposite to the inserting direction ID.

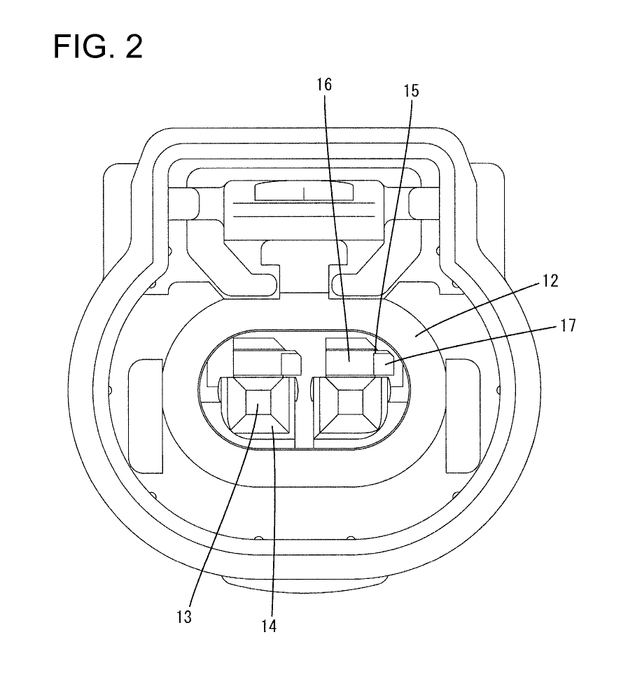

As shown in FIGS. 1, 2, 4 and 6, a receiving surface 17 is formed on the front end surface of the locking lance 15 and is arranged to be adjacent to the locking surface 16 in the lateral direction LD. The receiving surface 17 is at a position deviated from the rectangular tube 31 in the lateral direction LD. The receiving surface 17 is inclined with respect to both the resilient deforming direction DD of the locking lance 15 and the moving direction MD of the jig 40. The receiving surface 17 is pushed by an unlocking surface 46 of the jig 40 from front.

The front retainer 18 particularly is mounted to be externally fitted on the main body 12 from front and/or is held or positioned at a partial locking position shown in FIGS. 3 to 6 and a full locking position (not shown) located behind the partial locking position. The front retainer 18 includes a front wall 19 substantially corresponding to the front end surface of the main body 12 and/or a tubular portion 20 extending backward in a cantilever manner from the outer periphery of the front end surface 19 and surrounding the main body 12 particularly substantially over the entire circumference. The front wall 19 is formed with one or more through holes 21 corresponding to the respective terminal accommodating chamber(s) 13.

The lower surface (surface substantially facing the locking lances 15) of an upper wall portion 22 forming the tubular portion 20 is partly recessed to form a deformation space 23. The formation range of the deformation space 23 in forward and backward directions FBD is a rear end area of the upper wall portion 22. The deformation space 23 is open to a side behind the upper wall portion 22 (tubular portion 20). An area of the lower surface of the upper wall portion 22 located substantially in a central part in forward and backward directions FBD and/or before or adjacent to the front end of the deformation space 23 serves as a deformation restricting portion 24. The rear end of the deformation restricting portion 24 and the front end of the deformation space 23 particularly are connected via a step.

As shown in FIGS. 5 and 6, an area of the upper wall portion 22 where the deformation space 23 is formed is located above or outside of the locking lances 15 in a state where the front retainer 18 is held at the partial locking position. Thus, the locking lances 15 can be resiliently deformed in the deforming direction DD or upward or outward (unlocking direction) while at least partly entering the deformation space 23. This enables an operation of inserting the terminal fittings 30 into the terminal accommodating chambers 13 and an operation of withdrawing the terminal fittings 30 from the terminal accommodating chambers 13. Further, when the front retainer 18 is moved to the full locking position, the deformation restricting portion 24 of the upper wall portion 22 particularly substantially comes into contact with or come to proximately face the upper surfaces of the locking lances 15, thereby restricting the upward or outward resilient deformation of the locking lances 15. Since the disengagement of the locking lances 15 from the locking portions 32 of the terminal fittings 30 is reliably prevented in this way, the terminal fitting(s) 30 is/are reliably retained.

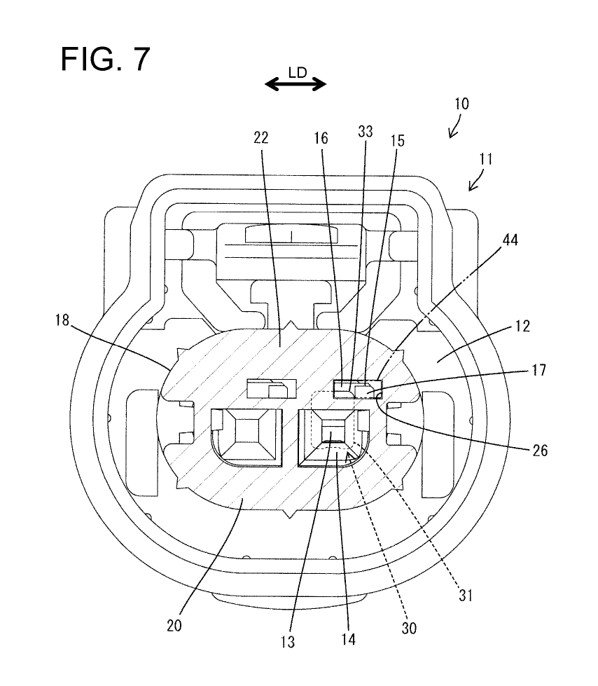

The front retainer 18 is formed with one or more guiding portions 25 for restricting displacements of the jig 40 in the vertical and/or lateral directions in moving the jig 40 for unlocking. The guiding portion 25 is composed of or comprises a guide hole 26 formed in the front wall 19 and/or a guide groove 27 formed in the lower surface of the upper wall portion 22. As shown in FIGS. 1 and 7, the guide hole 26 particularly has a rectangular shape whose lateral dimension particularly is longer than a vertical dimension and/or penetrates through the front wall 19 in forward and backward directions FBD. The guide groove 27 forms an area of the lower surface of the upper wall portion 22 before or adjacent to the deformation space 23 and/or extends in forward and backward directions FBD. The upper surface of the guide groove 27 and that of the guide hole 26 particularly substantially are continuous and flush with each other and/or opposite left and/or right side surfaces of the guide groove 27 and that/those of the guide hole 26 are continuous and flush with each other.

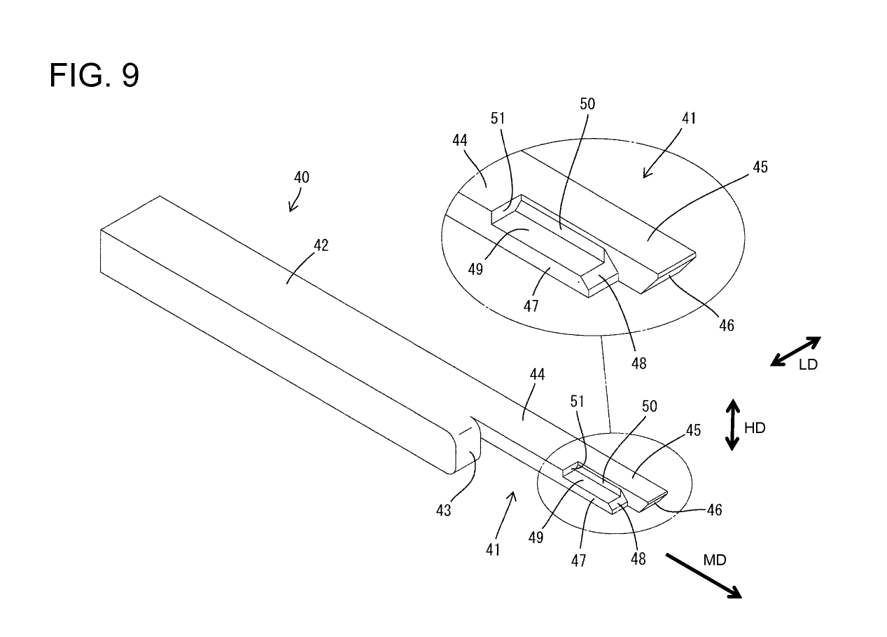

The jig 40 is used to release the locked state of the terminal fitting 30 by the locking lance 15 in withdrawing the terminal fitting 30 from the terminal accommodating chamber 13. As shown in FIG. 9, the jig 40 is long and narrow in forward and backward directions as a whole. In unlocking the locking lance 15, the jig 40 is inserted into the housing 11 in the moving direction ID particularly substantially from front as shown in FIGS. 3 to 6.

Note that, in the following description, a direction inserted into the housing 11 is referred to as a forward direction concerning forward and backward directions of the jig 40. Thus, forward and backward directions FBD in the housing 11 and those in the jig 40 are directly opposite. The vertical and lateral directions are based on a state where the jig 40 is inserted in the housing 11 during the unlocking operation. Thus, vertical and lateral orientations are opposite in a perspective view shown in FIG. 9.

The jig 40 particularly is made of metal and/or is composed of or comprises a disengaging portion 41 and a grip portion 42. The disengaging portion 41 is long and narrow in forward and backward directions as a whole and arranged at or near a front end part of the jig 40 in forward and backward directions. A long and narrow part of the jig 40 behind the disengaging portion 41 serves as the grip or operating portion 42. An operator performs an unlocking operation particularly by griping the grip portion 42. A lateral dimension of the grip portion 42 is longer than that of the disengaging portion 41 and, due to this dimensional difference, a stopper 43 particularly is formed in an area of the front end surface of the grip portion 42 where the disengaging portion 41 is not formed.

The disengaging portion 41 includes a guidable portion 44, an unlocking portion 45, the unlocking surface 46, a support 47, a guiding surface 48, a terminal pushing portion 50 and/or a push-back portion 51. A rear end part of the disengaging portion 41 particularly serves as the guidable portion 44 long and narrow in forward and backward directions. A cross-section of the guidable portion 44 perpendicular to a length direction (forward and backward directions) particularly has a rectangular shape whose lateral dimension is longer than a vertical direction. As shown in FIGS. 3 to 7, the guidable portion 44 is to be tightly inserted into the guide holes 26 of the front retainer 18 without shaking in the vertical and/or lateral directions.

The unlocking portion 45 long in forward and backward directions particularly substantially extends forward in a cantilever manner from the front end of the guidable portion 44. A lateral dimension of the unlocking portion 45 particularly is less than about 2/3, more particularly substantially half that of the guidable portion 44, and/or a vertical dimension thereof particularly is equal to that of the guidable portion 44. The upper and lower surfaces of the unlocking portion 45 are respectively continuous and flush with that/those of the guidable portion 44. Further, the right side surface of the unlocking portion 45 in a posture moving toward the housing 11 is continuous and flush with the right side surface of the guidable portion 44. The front end surface of the unlocking portion 45 particularly is formed into the unlocking surface 46 inclined with respect to the length direction or lateral surface of the jig 40 (unlocking portion 45). The unlocking surface 46 particularly is inclined downward toward the front during the unlocking operation.

The support 47 is a plate that is long in forward and backward directions and is cantilevered from an area of the front end of the guidable portion 44 displaced from the unlocking portion 45 in the lateral direction LD. A lateral dimension of the support 47 is less than that of the guidable portion 44 e.g. substantially half that of the guidable portion 44, and a vertical dimension thereof is equal to those of the guidable portion 44 and the unlocking portion 45. The upper surface of the support 47 is continuous and flush with those of the guidable portion 44 and/or the unlocking portion 45. The left side surface of the support 47 is substantially continuous and flush with the left side surface of the guidable portion 44. Further, the right side edge of the support 47 and the facing left side edge of the unlocking portion 45 are directly connected.

The front end of the support 47 is located behind that of the unlocking portion 45 (unlocking surface 46) in forward and backward directions. The front end surface of the support 47 is formed into the guiding surface 48 inclined with respect to the length direction or lateral surface of the jig 40 (unlocking portion 45). The guiding surface 48 is inclined up toward the front during the unlocking operation, the inclination of the guiding surface 48 being vertically opposite to that of the unlocking surface 46.

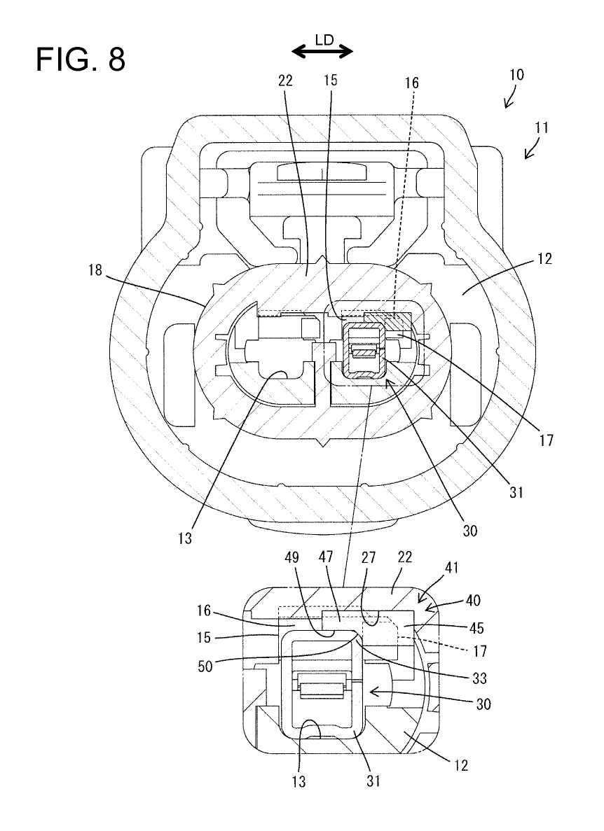

Since the thickness (vertical dimension along the height direction HD) of the support 47 is smaller than that of the unlocking portion 45, there is a height difference between the lower surface of the support 47 and that of the unlocking portion 45. Due to this height difference, the disengaging portion 41 is formed with a recess 49 having a substantially L-shaped cross-section and facing the lower surface of the supporting portion 47 and the left side surface of the unlocking portion 45. The recess 49 is open toward the front of the jig 40. As shown in FIG. 8, a corner 33 of the tube 31 is accommodated in the recess 49 during the unlocking operation by the jig 40.

The terminal pushing portion 50 oblique to the lower surface of the supporting portion 47 and the left side surface of the unlocking portion 45 is formed on a corner where the lower surface of the support 47 and the left side surface of the unlocking portion 45 are connected substantially at a right angle of the recess 49. The terminal pushing portion 50 is formed continuously from the front end to the rear end of the support 47 in forward and backward directions.

Further, since the support 47 is thinner than the guidable portion 44, there is a height difference between the lower surface of the support 47 and a front end part of the lower surface of the guidable portion 44. Due to this height difference, a front end part of the guidable portion 44 particularly serves as the step-like push-back portion 51. The front end surface of the push-back portion 51 is facing the recess 49.

Next, functions of this embodiment are described. In releasing the locked state by the jig 40 to withdraw the terminal fitting 30 from the terminal accommodating chamber 13, the front retainer 18 is moved to the partial locking position in advance and, thereafter, the jig 40 at least partly is inserted into the guide hole 26 with the disengaging portion 41 in the lead. In the process of moving the jig 40 for the unlocking operation, the disengaging portion 41 slides in contact with the guide hole 26 and/or the guide groove 27 from the start to the end of the operation, whereby the jig 40 is kept positioned in the vertical and/or lateral directions.

In the process of moving the jig 40, the terminal pushing portion 50 comes into contact with the tube 31 , particularly with the corner 33 where the upper and lateral side outer surfaces of the rectangular tube 31 are connected at a substantially right angle and displaces the tube 31 by pushing it particularly in an oblique downward direction (i.e. diagonal direction) as shown in FIG. 8. In this way, the rectangular tube 31 is pushed against a corner where the lower and side surfaces of the terminal accommodating chamber 13 are connected, and held in a stable posture without being inclined in the vertical and lateral directions. Since the pushing direction by this terminal pushing portion 50 is a direction of moving the tube 31 substantially away from the locking lance 15 with respect to the resilient deforming direction DD of the locking lance 15, an engagement margin between the locking portion 32 and the locking lance 15 is reduced by a displacement of the tube 31. Since the terminal pushing portion 50 extends continuously parallel to the moving direction MD of the jig 40, the rectangular tube 31 is kept pushed by the terminal pushing portion 50 during the movement of the jig 40.

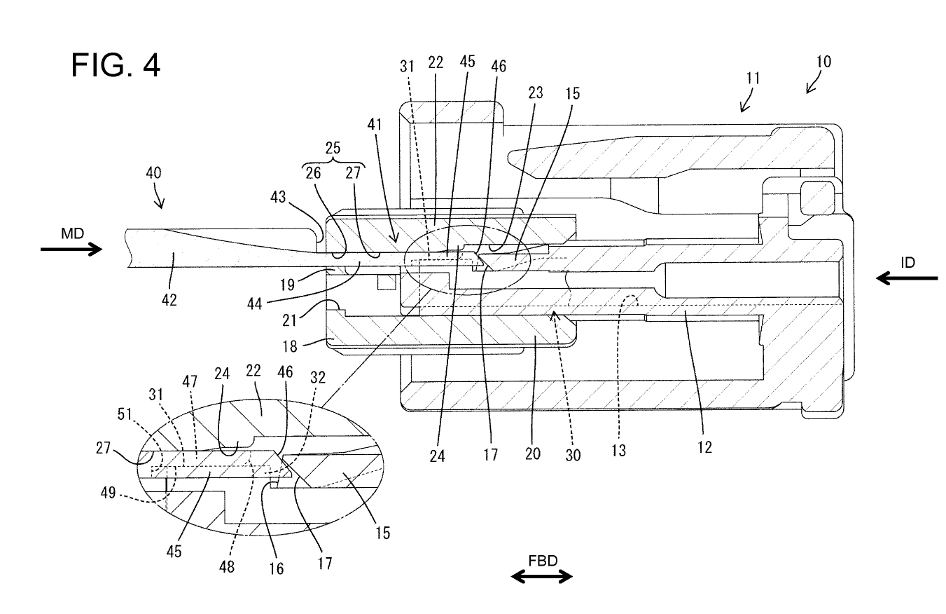

When the jig 40 is further moved, the unlocking surface 46 of the jig 40 comes into contact with the receiving surface 17 of the locking lance 15 before the push-back portion 51 reaches the front end of the tube 31 as shown in FIG. 4. Also at this point, the tube 31 is kept pushed by the terminal pushing portion 50. When the jig 40 is further moved in this state, the unlocking surface 46 and the receiving surface 17 slide in contact with each other and the locking lance 15 is resiliently deformed in the deforming direction DD or up in an unlocking direction due to the inclination of the both surfaces 46, 17 as shown in FIG. 6. Associated with this resilient deformation of the locking lance 15, an engagement margin between the locking surface 16 and the locking portion 32 is reduced and, finally, the locking surface 16 is completely disengaged from the locking portion 32 as shown in FIG. 5. Since the locked state of the terminal fitting 30 by the locking lance 15 is released in this way, a backward displacement of the terminal fitting 30 is permitted.

The jig 40 is or can be further moved in the moving direction MD in this state particularly until the stopper 43 comes into contact with the front end surface of the front retainer 18. Then, as shown in FIG. 5, the push-back portion 51 pushes the (rectangular or polygonal) tube portion 31 from front, whereby the terminal fitting 30 is pushed back to the back side of the terminal accommodating chamber 13. During this time, the locking lance 15 is kept resiliently deformed by the unlocking surface 46. When the terminal fitting 30 is pushed back, the locking portion 32 slips under the locking lance 15. Thus, the locking lance 15 cannot be resiliently restored to the position where it is engaged with the locking portion 32. When the stopper 43 comes into contact with the front end surface of the front retainer 18, the unlocking operation by the jig 40 is completed. Thereafter, hand may be removed from the jig 40 and the terminal fitting 30 may be pulled out backward.

The locking lance 15 is pushed by the unlocking surface 46 inclined with respect to both the resilient deforming direction DD of the locking lance 15 and the moving direction MD of the jig 40 in unlocking the locking lance 15. Thus, the movement stroke of the jig 40 necessary for unlocking is substantially proportional to the amount of resilient deformation of the locking lance 15 necessary for unlocking. Thus, if the amount of resilient deformation necessary to unlock the locking lance is large, the movement stroke of the jig becomes longer by that much, which may lead to a reduction in operability.

Accordingly, besides the unlocking surface 46, the jig 40 is formed with the terminal pushing portion 50 for pushing and displacing the terminal fitting 30 in the direction away from the locking lance 15 with respect to the resilient deforming direction DD of the locking lance 15 in the moving process of the jig 40 during the unlocking operation. Since the amount of resilient deformation necessary for unlocking is reduced by the presence of this terminal pushing portion 50, the movement stroke of the jig 40 necessary for unlocking becomes shorter by that much. Therefore, operability is excellent.

The jig 40 also is formed with the push-back portion 51 for pushing back (or in a withdrawal direction) the terminal fitting 30 in the direction to separate the terminal fitting 30 from the terminal accommodating chamber 13 after the locking lance 15 is unlocked in the moving process during the unlocking operation. According to this configuration, since the terminal fitting 30 is pushed back by the push-back portion 51 when the unlocking operation is completed, the terminal fitting 30 and the locking lance 15 interfere with each other and the locking lance 15 is kept in an unlocked state even without being resiliently deformed by the jig 40. Thereafter, the terminal fitting 30 can be withdrawn even without performing the unlocking operation by the jig 40. Thus, operability is better as compared with the case where the terminal fitting 30 is withdrawn with the unlocking operation by the jig 40 continued.

The terminal pushing portion 50 pushes the corner 33 of the rectangular tube 31 in the diagonal direction (i.e. direction oblique to the two outer surfaces of the rectangular tube 31 connected to the corner 33 and at a substantially right angle to each other. This causes the rectangular tube 31 pushed by the terminal pushing portion 50 to be pressed against the corner of the terminal accommodating chamber 13. By configuring the terminal pushing portion 50 to push the corner 33 of the rectangular tube 31, a contact area when the terminal pushing portion 50 pushes the terminal fitting 30 is smaller as compared with the case where the terminal pushing portion 50 pushes a planar portion of the rectangular tube 31 while being held in surface contact therewith. Since sliding resistance between the terminal pushing portion 50 and the rectangular tube 31 is reduced by that much, operability is excellent.

The jig 40 particularly is further formed with the stopper 43 which comes into contact with the housing 11 when the jig 40 is moved to a position where the unlocking portion is completed. Thus, if it is determined as an operation manual to move the jig 40 until the stopper 43 comes into contact with the housing 11, the unlocking operation by the jig 40 can be reliably completed.

If the jig 40 is displaced in a direction intersecting with the moving direction MD in the process of being moved to resiliently deform the locking lance in the unlocking direction, the unlocking surface 46 pushes the locking lance 15 at a timing other than a specified one and the resilient deformation of the locking lance 15 may be insufficient. In this case, operability is reduced since the jig 40 needs to be moved again. Accordingly, the housing 11 is formed with the guiding portion 25 extending along the moving direction MD of the jig 40 during the unlocking operation and improper displacements of the jig 40 in directions intersecting with the moving direction MD are restricted by this guiding portion 25. This guiding portion 25 particularly eliminates a possibility that the locking lance 15 is pushed at a timing other than a specified one by the unlocking surface 46 due to a displacement of the jig 40. Since the locking lance 15 can be reliably resiliently deformed as much as necessary in this way, operability is excellent.

The present invention is not limited to the above described and illustrated embodiment. For example, the following embodiments are also included in the technical scope of the present invention.

Although the unlocking surface pushes the locking lance after the terminal pushing portion displaces the terminal fitting in the moving process during the unlocking operation in the above embodiment, the terminal pushing portion may displace the terminal fitting after the unlocking surface pushes the locking lance.

Although the jig is formed with the push-back portion in the above embodiment, it may not be formed with the push-back portion.

Although the jig is formed with the stopper in the above embodiment, it may not be formed with the stopper.

Although the moving direction of the jig in unlocking the locking lance is substantially parallel to the insertion direction of the terminal fitting in the above embodiment, it may be a direction intersecting with the insertion direction of the terminal fitting.

Although the terminal pushing portion pushes the corner edge portion of the (rectangular or polygonal) tube portion of the terminal fitting in the oblique direction (diagonal direction) with respect to the resilient deforming direction of the locking lance in the above embodiment, it may push the (rectangular or polygonal) tube portion in a direction substantially parallel to the resilient deforming direction of the locking lance.

Although the housing is formed by assembling the two members, i.e. the main body formed with the terminal accommodating chambers and the front retainer in the above embodiment, it may be composed of a single member.

What is claimed is:

1. A jig (40) to be used for a connector (10) including a locking lance (15) resiliently deformable in a direction (DD) intersecting with an insertion direction (ID) of a terminal fitting (30) into a terminal accommodating chamber (13) and configured to retain the terminal fitting (30) at least partly inserted into the terminal accommodating chamber (13) by the locking action of the locking lance (15), the jig (40) being configured to resiliently deform the locking lance (15) in an unlocking direction (DD) by being moved in a direction (MD) intersecting with a resilient deforming direction (DD) of the locking lance (15) in unlocking the locking lance (15), comprising:
an unlocking surface (46) which is inclined with respect to both the resilient deforming direction (DD) of the locking lance (15) and a moving direction (MD) of the jig (40) and which is able to push and resiliently deform the locking lance (15) in the unlocking direction (DU) in a moving process during an unlocking operation; and
a terminal pushing portion (50) which pushes and displaces the terminal fitting (30) in a direction away from the locking lance (15) with respect to the resilient deforming direction (DD) of the locking lance (15) in the moving process during the unlocking operation.

2. The jig of claim 1, further comprising a push-back portion (51) which pushes back the terminal fitting (30) in a direction to separate the terminal fitting (30) from the terminal accommodating chamber (13) after the locking lance (15) is unlocked in the moving process during the unlocking operation.

3. The jig of claim 2, wherein the terminal pushing portion (50) is configured to push a corner of a tube (31), which is formed on the terminal fitting (30) and to be locked by the locking lance (15), in a diagonal direction.

4. The jig of claim 1, further comprising a stopper (43) that contacts a housing (11) of the connector (10) when the jig (40) is moved to a position where the unlocking operation is completed.

5. The jig of claim 1, further comprising a guidable portion (44) is to be tightly inserted into a guide hole (26) of the connector (10) without shaking in vertical and/or lateral directions.

6. The jig of claim 1, wherein the disengaging portion (41) includes a support (47) substantially in the form of a plate long in forward and backward directions, the support (47) extending forward from the guidable portion (44) and displaced laterally from the unlocking portion (45).

7. The jig of claim 6, wherein a lateral dimension of the support (47) is less than a lateral dimension of the guidable portion (44) and a vertical dimension of the support (47) is equal to vertical dimensions of the guidable portion (44) and the unlocking portion (45).

8. A connector (10), comprising:
a housing (11) formed with at least one terminal accommodating chamber (13);
at least one terminal fitting (30) to be inserted into the terminal accommodating chamber (13); and
at least one locking lance (15) extending substantially along an inner wall of the terminal accommodating chamber (13) and being resiliently deformable in a direction (DD) intersecting an insertion direction (ID) of the terminal fitting (30), the locking lance (15) being configured to engage and retain the terminal fitting (30);
the terminal fitting (30) being displaced in a direction away from the locking lance (15) with respect to a resilient deforming direction (DD) of the locking lance (15) by a terminal pushing portion (50) of a jig (40) and the locking lance (15) being resiliently deformed in an unlocking direction (DD) by an unlocking surface (46) of the jig (40) in the process of moving the jig (40) in a direction (MD) intersecting the resilient deforming direction (DD) of the locking lance (15);
wherein at least one guiding portion (25) is formed in the housing (11) to substantially extend along a moving direction (MD) of the jig (40) during an unlocking operation and restricts improper displacements of the jig (40) in directions intersecting with the moving direction (MD) of the jig (40).

9. The connector of claim 8, comprising a receiving surface (17) arranged to be adjacent to a locking surface (16) of the locking lance (15) in a direction intersecting with the resilient deforming direction (DD) of the locking lance (15) is formed on the locking lance (15), wherein the receiving surface (17) particularly is arranged at a position deviated from the tube portion (31) in the lateral direction (LD) and/or wherein the receiving surface (17) particularly is inclined with respect to both the resilient deforming direction (DD) of the locking lance (15) and the moving direction (MD) of the jig (40).
